(19) United States
(12) Patent Application Publication
(10) Pub. No.: US 2014/0173125 A1
(43) Pub. Date: Jun. 19, 2014

(54) SYSTEMS AND METHODS FOR TRANSFERRING A SESSION BETWEEN DEVICES IN AN ON-DEMAND COMPUTING ENVIRONMENT

(71) Applicant: salesforce.com, inc., San Francisco, CA (US)

(72) Inventor: Piranavan Selvanandan, San Francisco, CA (US)

(73) Assignee: salesforce.com, inc., San Francisco, CA (US)

(21) Appl. No.: 14/100,666

(22) Filed: Dec. 9, 2013

Related U.S. Application Data
(60) Provisional application No. 61/738,941, filed on Dec. 18, 2012.

(51) Int. Cl. H04L 29/06; H04L 29/08

(52) U.S. Cl. CPC H04L 63/10; H04L 67/141
USPC 709/229; 709/227

(57) ABSTRACT

A method is provided for transferring a session between at least two user devices. The method includes receiving a transfer command from a first user device during a session to initiate a session transfer; generating a session code representing the session; receiving the session code from a second user device; and reestablishing the session with the second user device.

### CROSS-REFERENCE TO RELATED APPLICATION

This application claims the benefit of U.S. provisional patent application Ser. No. 61/738,941, filed Dec. 18, 2012.

### TECHNICAL FIELD

Embodiments of the subject matter described herein generally relate to an on-demand computing environment. More particularly, exemplary embodiments relate to systems and methods for transferring sessions between devices in an on-demand computing environment.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. The multi-tenant platform operator may make improvements to the platform based upon collective information from the entire tenant community, as well as improving collaboration and integration between applications and the data managed by the various applications. The multi-tenant architecture therefore allows convenient and cost effective sharing of similar application features between multiple sets of users.

As such, the multi-tenant system is configured to enable the authorized users to access stored data during an application session over a network. One advantage of the cloud computing model is that such sessions may be conducted on any type of device, including desktop computers and mobile devices from any network accessible location. However, when engaged in a session on a first device, it may be inconvenient for a user to change to another device. Typically, the user may be required to end a first session on the first device and start a new session on the second device.

Accordingly, it is desirable to provide systems and methods for transferring sessions in an on-demand environment between multiple devices. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exemplary system for establishing, managing, and transferring data application sessions in accordance with an exemplary embodiment;

FIG. 2 is a diagram that illustrates data flows associated with the transfer of a session between user devices in accordance with an exemplary embodiment;

FIGS. 3-5 are views generated and displayed by the system of FIG. 1 in accordance with an exemplary embodiment;

FIG. 6 is a flow chart that illustrates an exemplary embodiment of a method for transferring a session between user devices in accordance with an exemplary embodiment; and

FIG. 7 is a block diagram of an exemplary multi-tenant data processing environment associated with the system of FIG. 1 in accordance with an exemplary embodiment.

### DETAILED DESCRIPTION

Exemplary embodiments discussed herein provide improved systems and methods for transferring a session between user devices in a multi-tenant environment. In particular, during a session on the first user device, a user may request a transfer, and in response, the application module generates a unique session code representing the session. In one exemplary embodiment, the session code may be embodied as a QR code displayed on the first user device. The session code may be used to reestablish the session on a second user device.

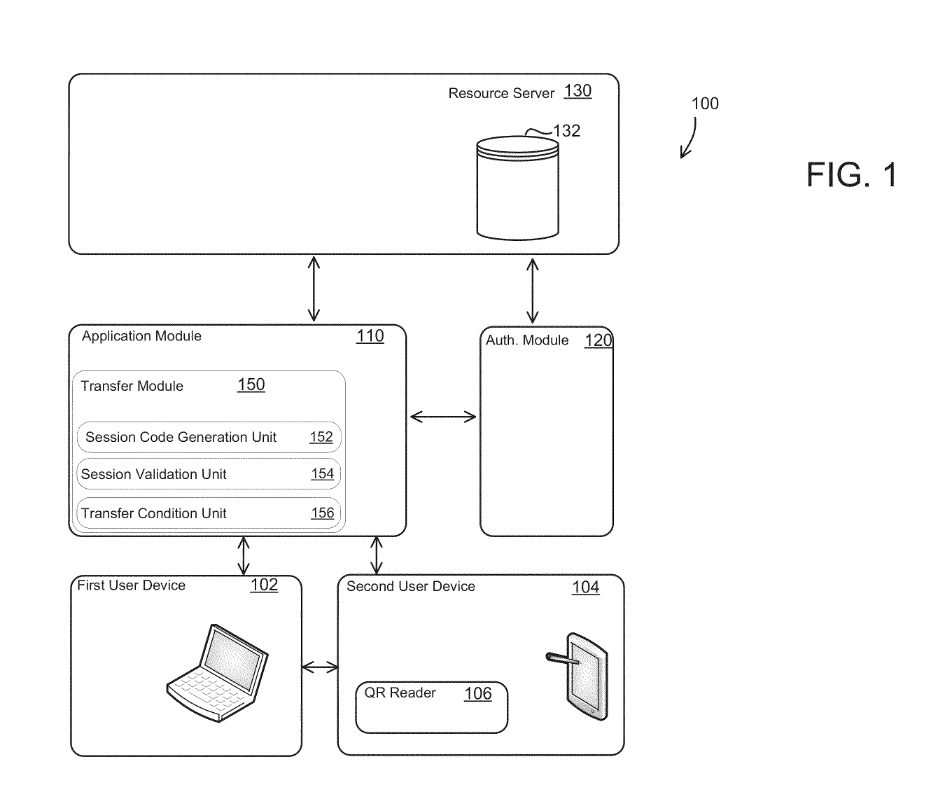

FIG. 1 is a diagram that illustrates an exemplary environment associated with the establishment, management, administration, and transfer of application sessions between user devices. FIG. 1 depicts a simplified system 100 having an application module 110, an authorization module 120, and a resource server 130. FIG. 1 additionally depicts first user device 102 and second user device 104 that enable one or more users to interact with the system 100. In general, a user may be any person desiring access to the data resources via the application module 110. In one exemplary embodiment, the user of the first and second user devices 102, 104 is the same user. In other embodiments, the first and second user devices 102, 104 may be associated with different users. Although FIG. 1 depicts two user devices 102, 104, the system environment may support a number of such user devices 102, 104.

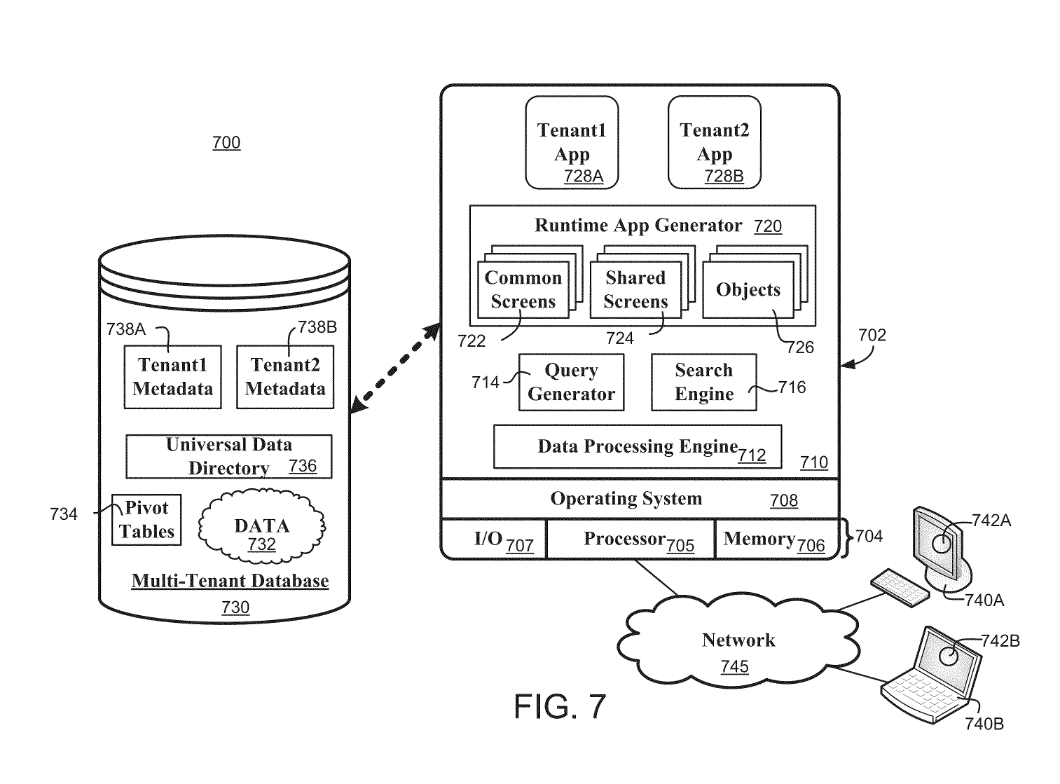

Although not depicted in FIG. 1, the system 100 may be deployed in the context of a multi-tenant application system, such as a system described below with reference to FIG. 7. Alternatively, system 100 may be deployed in a different on-demand environment, for example, a client-server network, a virtual machine-based system, a mobile and cellular phone networks, etc. A general description of the user devices 102, 104, the application module 110, the authorization module 120 and/or the resource server 130 will be briefly provided prior to a more detailed description. FIG. 1 depicts functional units that might be realized using, for example, one or more processors, a data processing engine, or other computer-implemented logic resident in the system 100. In this regard, each of the user devices 102, 104, the application module 110, the authorization module 120, and/or the resource server 130 may represent, without limitation: a piece of hardware (such as a computer, a mobile electronic device, or any processor-based computing device); a functional, logical, or processing module of a piece of hardware; a software-based application that executes at a piece of hardware; or the like. In certain embodiments, the units may be realized as one more web-based applications, desktop applications, object-oriented scripts running on webpages, or the like, which are suitably designed to perform the various client module tasks, processes, and procedures described in more detail herein.

In general, the user devices 102, 104 may be any sort of personal computer, mobile telephone, tablet or other network-enabled user device for accessing the system 100. As such, the first and second user devices 102, 104 may include any suitable control and communication systems, memory, processors, display, input devices and the like for supporting interaction with the system 100 over a network, including the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. The user devices 102, 104 may additionally include applications for generating, receiving, and processing various types of communication forms, including, as examples, barcodes, QR (quick response) codes, optical character recognition (OCR), emails, SMS (short messaging service), URL (uniform resource locator), NFC (near field communications) URL, websockets, MMS (multimedia messaging service), a dedicated short code, and or any other suitable messaging protocol. As discussed below, the user devices 102, 104 gain access to the system via the application module 110 by establishing a session over a network using a browser or other application executed on the respective user device 102, 104.

In the examples provided below, the first user device 102 is generally referenced as a desktop computer, and the second user device 104 is generally referenced as a mobile device, although the user devices 102, 104 are not limited to these forms. In the scenarios discussed below, the first user device 102 is associated with a first user and the second user device 104 is associated with the first user or a second user with whom the first user wants to share a session. As described in greater detail below, the system 100 enables the first user to transfer a session from the first user device 102 to the second user device 104. In general, a session may be considered an interactive information exchange between the user device 102, 104 and the system 100, typically established at a certain point in time and ended at a later point in time. During the session, the system 100 may maintain session management to track user activity within the application.

As noted above, in one exemplary embodiment, one or more of the user devices 102, 104, particularly the second user device 104, is a mobile device that includes a mobile platform with a browser or application providing an interface with the system 100. In one exemplary embodiment, the second user device 104 further includes a QR reader 106 configured to optically scan QR codes. Broadly, a QR code is a unique two-dimensional code that is readable by computer devices (e.g., the QR reader 106). A QR code typically includes black modules arranged in a square pattern on a white background and may be created by any commercially available application which generates QR codes from data sets, as described below. The QR code may be defined according to an ISO standard.

The QR reader 106 may be native to the operating system of the user device 104 or the QR reader may be separate application. In addition to scanning QR codes, the QR reader 106 is configured to interpret the data within the scanned QR code and perform the functions associated with the data. As an example, the second user device 104 may use an application program interface (API) to initiate a session transfer request based on the QR code, e.g., by calling on a URL embedded in the QR code, opening the browser or application stored on the second user device 104, and sending the request to the application module 110, as discussed below.

Generally, the application module 110 is a server or system that supports a network accessible software application. For example, the application module 110 may be any sort of software application or other data processing engine that supports one or more applications that provide data and/or services to the user devices 102, 104. In one exemplary embodiment, such applications may be virtual applications are typically generated at run-time in response to queries received from the user devices 102, 104. As such, the application module 110 may include a data processing engine, a query generator, a search engine, and a runtime application generator. Each of these features may be implemented as a separate process or other module, and many equivalent embodiments could include different and/or additional features, components or other modules as desired. FIG. 1 depicts only one application module 110 in the system 100. In practice, however, the authorization module 120 and/or the resource server 130 may support a plurality of different application modules.

The application module 110 may be configured to generate and provide any number of GUIs, GUI elements, web pages, resources, and/or displays on the user devices 102, 104, as needed to support the desired functionality. For example, GUI displays and screen views are configured to render as web pages presented using a web browser running on the respective user device 102, 104. In some embodiments, the application module 110 may interact with additional systems or services, for example, via third party API integration, to interact with or conduct sessions with the user devices 102, 104.

In one exemplary embodiment, the application module 110 further includes a transfer module 150, which includes a session code generation unit 152, a session validation unit 154, and a transfer condition unit 156. As discussed in greater detail below, the session code generation unit 152 is configured to, based on commands from the user (e.g., via the first user device 102), evaluate the status of a session, generate a session code representing the session, and present the session code to the user (e.g., on the first user device 102). As noted above, the session code may have any suitable form, such as a QR code displayed on the first user device 102 for scanning by second user device 104. As also discussed in greater detail below, the session validation unit 154 generally functions to receive a session request from a user (e.g., from the second user device 104) with session information, confirm the established session and user authentication, and if acceptable, reestablish the session (e.g., on the second user device 104). The transfer module 150 may store the session code, e.g., as a bookmark or bookmarklet, that defines, references or maps to the corresponding session.

As described in greater detail below, the transfer condition unit 156 may function to generate condition options that enable the user to place conditions on the transfer. The transfer condition unit 156 may additionally store transfer conditions and provide the transfer conditions to the session code generation unit 152 for implementation. Any suitable transfer conditions may be established, including access or operation restrictions and duration limits. The transfer conditions may further limit or define particular aspects of the session for transfer, such as selected tabs or windows.

As described below, the transfer conditions may enable the user of the first user device 102 to define the continued, transferred session in an asymmetric manner, particularly if the second user device 104 is associated with a second user. For example, the transfer conditions may define asymmetric views in which the transferred session is a “read-only” view or is limited in time as defined by the user of the first user device 102, such as long as the code is displayed on the first user device 102, which upon closing, will terminate the session on either user device 102, 104. The transfer condition may also defined asymmetric actions or information, such as only providing certain information to the second user device 104. As an example of such limited information, the first user may want to transfer only contact information associated with the session to the second user device 104. In some embodiments, custom objects in the application module 110 may define or otherwise determine security privileges and the extent of the transfer conditions. Similarly, such transfer conditions may be identified via contact information within an organizational contact list. Additional details about the operation of the transfer module 150 will be provided below.

In general, the resource server 130 is suitably designed to host the protected data resources. As such, the resource server 130 may include a database 132 to store the protected data resources. The application module 110 may attempt to access the protected data resources in the resource server 130 on behalf of the user via the user devices 102, 104.

In general, the authorization module 120 may function to manage access to the protected data resources in the resource server 130, for example, by authenticating users of the application module 110. Accordingly, authorization module 120 may store access protocols that define rights, privileges, and capabilities associated with the protected data resources as authorized by the owner of the data, such as an organization or employer of the user. The authorization module 120 may authenticate the user in view of the access protocols, for example, by requesting and receiving user credential from the user device 102, 104. Moreover, although the authorization module 120 and the resource server 130 are depicted as distinct elements, the two could be realized as a single logical element, module, or hardware device.

In one exemplary embodiment, the authorization module 120 and resource server 130 may use an OAuth authorization protocol. As such, the application module 110, the authorization module 120, and the resource server 130 may utilize access tokens that define data access rights, privileges, or capabilities. In particular, the authorization module 120 may generate access tokens that define these data access attributes. As used in this description, an “access token” is digital data that represents an authorization issued to an entity, application, module, or element that seeks access to protected data, to access system features, to access system functionality, and the like. In practice, an access token can be realized as a string of bits that defines or otherwise indicates, without limitation: a scope of data access granted to the token holder; a duration of data access granted to the token holder; data access capabilities granted to the token holder; and/or particular system features or functionality accessible to the token holder.

Accordingly, during general operation, the application module 110, in response to a service request from the user devices 102, 104, requests access and authentication from the authorization module 120. If the credentials of the user are confirmed and the user is authorized to access the protected data resources according to access protocols, the authorization module 120 issues an access token, which the application module 110 may use to access the data from the resource server 130. In general, the application module 110 may send additional data requests within the scope of the access token until the access token expires. Other authentication protocols may be used. Typically, sessions are established and administered in this manner.

As will now be described, the system 100 is configured to enable the transfer of a session between the first user device 102 and the second user device 104. As noted above, the user may desire to transfer the session when changing locations, e.g., transitioning from a desktop computer (as the first user device 102) to a mobile device (as the second user device 104). In another scenario, the user of the first user device 102 may want to transfer the session to another user's device, e.g., the second user device 104, such that the session may be shared or such that the second user may continue the session initiated by the first user.

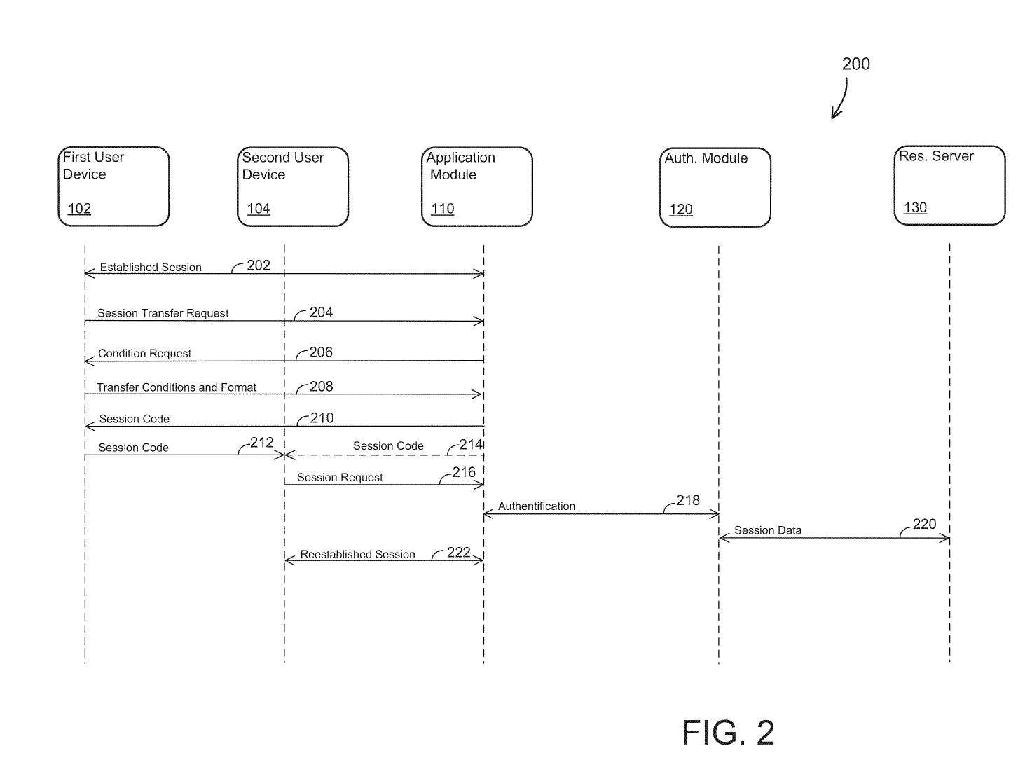

FIG. 2 is a diagram that illustrates data flows 200 associated with transferring application sessions in accordance with an exemplary embodiment. The data flows 200 may be associated, for example, with the system 100 described above with reference to FIG. 1. As such, FIGS. 1 and 2 will be referenced below.

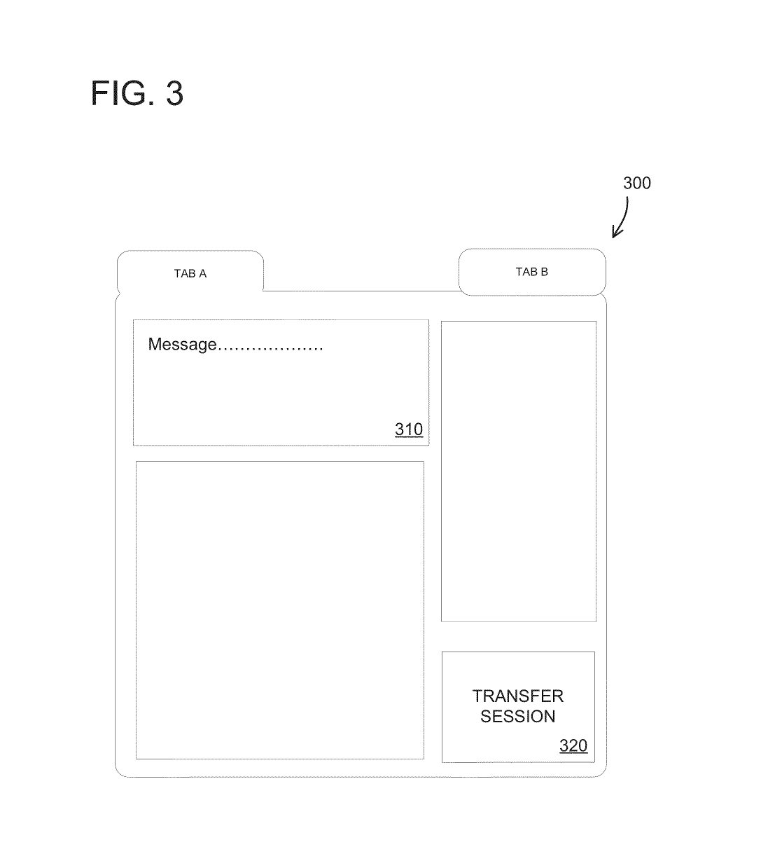

Initially, as represented by data flow 202, the user is engaged in a session with the system 100 on the first user device 102. As such, the first user device 102 has been authenticated by the authorization module 120 to access data in the resource server 130 via an application supported by the application module 110. Reference is briefly made to FIG. 3, which is an exemplary representation of a view 300 of a session displayed on the first user device 102. The application accessed by the user on the first user device 102, and thus the type of data accessed by the user on the first user device 102, may be any type of application and data. In the exemplary view 300 of FIG. 3, the user is composing a message in field 310 with a graphical user interface having any suitable GUI elements, features, components, functionality, and the like defined, for example, with configuration data. Such elements may include, for example, active links to online resources, web pages, or database objects; menus; tabs; forms; controls; or the like. The view 300 additionally depicts a transfer button 320 that, upon selection, initiates the session transfer to the second user device 104, as referenced above and discussed in greater detail below.

Returning to FIG. 2, as represented by data flow 204, the user initiates a session transfer by selecting the appropriate command (e.g., the transfer button 320), and in response, the first user device 102 sends a transfer request to the application module 110, which is received by the transfer module 150

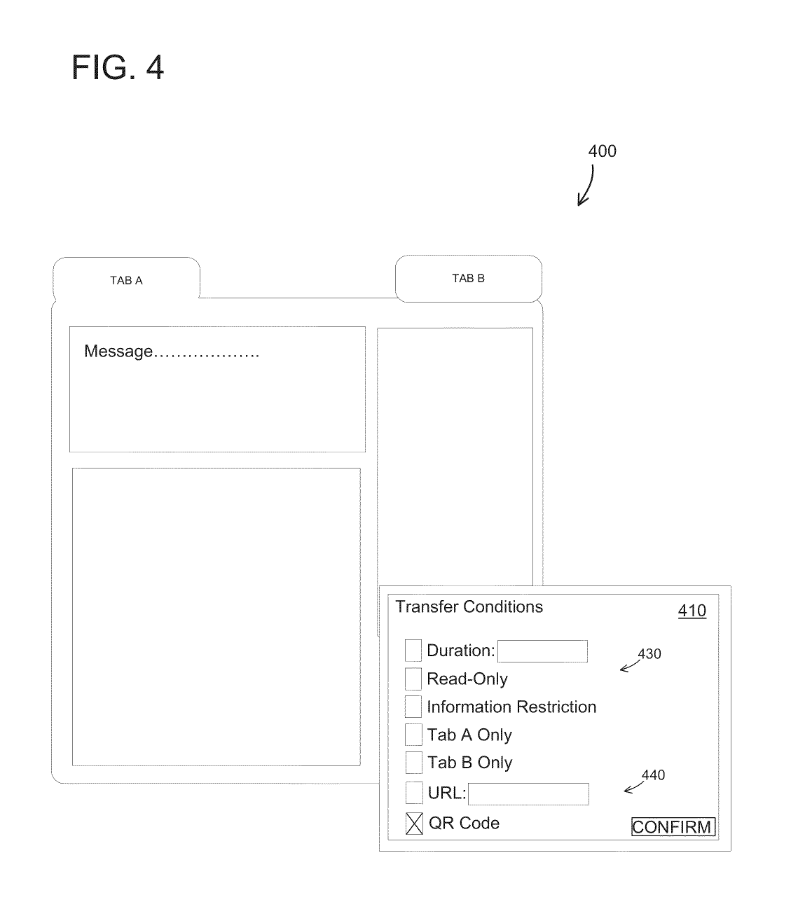

As represented by data flow 206, transfer condition unit 156 may generate and send a condition request to the first user device 102. Reference is briefly made to FIG. 4, which is another exemplary representation of the view 400 of a session displayed on the first user device 102. In particular, the view 400 of FIG. 4 is in response to selection of the transfer button 320 in FIG. 3 and receipt of the condition request in data flow 206.

As shown in FIG. 4, a transfer window 410 has been opened on the first user device 102 that includes a number of selections or conditions, including transfer condition selections 430 and code format selections 440. The transfer condition selections 430 may correspond to the transfer conditions described above, and in this example, the transfer condition selections 430 are embodied as a list of transfer conditions, although any form may be provided. As noted above, the transfer condition selections 430 define the nature of the transferred session on the second user device 104. The code format selections 440 enable the user to select the type or form of the session code, such as a QR code for display or an SMS or URL forwarded to a telephone number, internet address, or email address. Selection of the transfer conditions and code format provides confirmation of the transfer request.

Returning to FIG. 2, as represented by data flow 208, the first user device 102 sends the confirmation and any conditions or format information to the application module 110. As represented by data flow 210, transfer module 150 of the application module 110 generates and sends the session code to the first user device 102. In particular, the session code generation unit 152 of the transfer module 150 evaluates the current user session and generates the session code representing the session with consideration of the transfer conditions and code format, as applicable.

As introduced above, the session code may include any suitable type of information associated with the session. The session code may include a URL that, upon execution, directs the respective device to a resource location associated with the session stored by the application module 110. The session code may additionally or alternatively include other information, such as a session ID or other unique code representing the session; authentication information such as access tokens, keys, user credentials, or cookies; session duration; and any transfer conditions requested by the user in data flow 206. In some embodiments, data flows 206 and 208 may be omitted such that the application module 110 automatically generates a session code upon receipt of the transfer request.

Returning to FIG. 2, as represented by data flow 212, the first user device 102 sends or otherwise presents the session code to the second user device 104. For example, if the session code is embodied as an SMS or URL, the first user device 102 may wireless transmit the session code to the second user device 104. In another exemplary embodiment, represented by data flow 214, the application module 110 sends the session code to the second user device 104. In a further embodiment, the application module 110 may instruct a third party service (e.g., a file sharing service) to send the session code to the second user device 104.

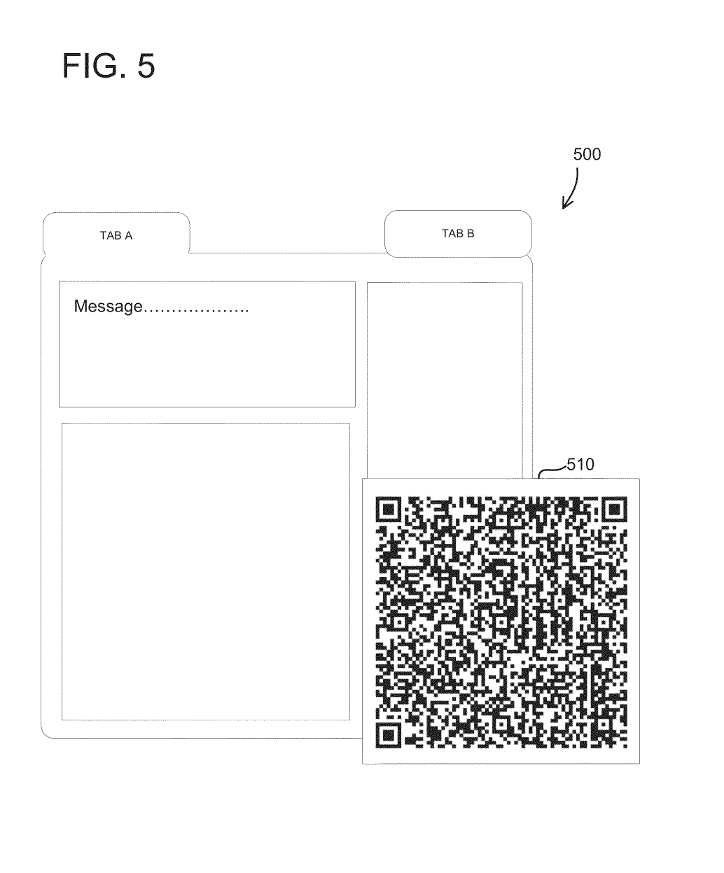

In another example, reference is briefly made to FIG. 5, which is an exemplary representation of a view 500 of a session displayed on the first user device 102 subsequent to the view 400 of FIG. 4. In this embodiment, the session code is in the form of a QR code 510 that may be displayed on the first user device 102 for scanning by the second user device 104. As discussed above, the second user device 104 includes a QR reader 106 for scanning QR codes, such as QR code 510 in FIG. 5. Upon scanning the QR code 510, the second user device 104 extracts the session information.

Upon receipt of the session code, the second user device 104 extracts the relevant information, such as a URL embedded in the session code, and sends a session request with the session code to the application module 110, as represented by data flow 216.

The transfer module 150 receives the session request from the second user device 104 and validates the session. In particular, the session validation unit 154 receives a session request, extracts the session code, confirms the session code represents a valid session, and if acceptable, reestablishes the session (e.g., on the second user device 104). In one exemplary embodiment, the session validation unit 154 confirms the session code by comparing the session code to stored session codes. In other embodiments, the session code includes session ID and authentication information from which the session validation unit 154 may reestablish the session. The session validation unit 154 may additionally evaluate and implement any transfer conditions that are embodied in or associated with the session code.

If additional authentication is needed or desired, the transfer module 150 of the application module 110 may send an authentication request to the authorization module 120 and, if authenticated, receives an authentication confirmation from the authorization module 120, as represented by data flow 218. As examples, the transfer module 150 may request and receive access tokens for accessing the data stored in the resource server 130. Additionally, if necessary, the application module 110 may additionally send data to and receive data from the resource server 130 to reestablish the session, as represented by data flow 220. As noted above, the session information enables the application module 110 to determine the appropriate in-progress session and reestablish the session.

As represented by data flow 222, the application module 110 establishes the session with the second user device 104, sending and receiving data as in the initial portion of the session with the first user device 102. As an example, the session may appear on the second user device 104 as it did on the first user device 102, e.g., as shown in FIG. 3. In one exemplary embodiment, the session on the second user device 104 may be displayed with GUI elements defined by the configuration data associated with the session from the first user device 102. As noted above, the session established on the second user device 104 may be subject to transfer conditions, such as limitations on views or operations.

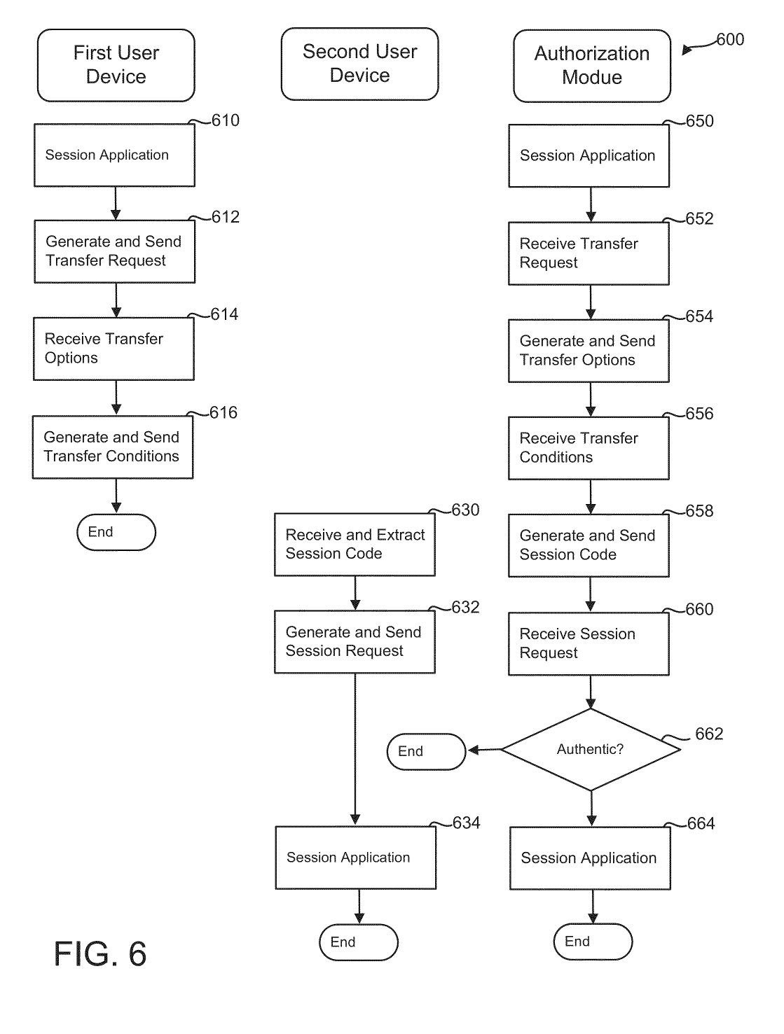

FIG. 6 is a flow chart that illustrates an exemplary embodiment of a session transfer process 600. The various tasks performed in connection with the process 600 may be performed by software, hardware, firmware, or any combination thereof. For illustrative purposes, the following description of the process 600 may refer to elements mentioned above in connection with FIG. 1. As such, FIGS. 1 and 6 are referenced below.

It should be appreciated that the process 600 may include any number of additional or alternative tasks, the tasks shown in FIG. 6 need not be performed in the illustrated order, and the process 600 may be incorporated into a more comprehensive procedure or process having additional functionality not described in detail herein. Moreover, one or more of the tasks shown in FIG. 6 could be omitted from an embodiment of the process 600 as long as the intended overall functionality remains intact.

For this particular embodiment, certain tasks of the process 600 are performed by first and second devices, such as the user devices 102, 104 discussed above, while other tasks are performed by an application module, such as the application module 110 discussed above. Accordingly, the first two columns of FIG. 6 correspond to tasks performed by the user devices 102, 104, respectively, and the third column side of FIG. 6 corresponds to tasks performed by the application module 110.

In initial steps 610 and 650, the first user device 102 and application module 110 are engaging in a session, as referenced above. In step 612, the first user device 102 generates and sends a transfer request to the application module 110. In step 652, the application module 110 receives the transfer request from the first user device 102. In step 654, the application module 110 generates and sends transfer condition options and code format options to the first user device 102. In step 614, the first user device 102 receives the transfer condition options, and in step 616, the first user device 102 generates and sends transfer conditions and code format to the application module 110. In step 656, the application module 110 receives the selected transfer conditions and code format, and in step 658, the application module 110 generates and sends a unique code that represents the session based on the transfer conditions and code format.

In step 630, the second user device 104 receives the session code, either as presented on or forwarded from the first device in an optional step or directly from the application module 110 in step 658. In step 632, the second user device 104 extracts and sends the session code to the application module 110. In steps 660 and 662, the application module 110 receives the code and authenticates the second user device 104. If the authentication fails, the application module 110 ends the process 600. In steps 634 and 664, the second user device 104 and the application module 110 reestablish the session from the initial steps.

Accordingly, systems and methods described above provide improved establishment, management, and administration of application sessions. In particular, the exemplary embodiments discussed above enable a session transfer between user devices, thereby improving efficiency by preventing and/or mitigating slow manual reestablishment of a session. The session transfer is particularly advantageous considering the increasing popularity and utility of mobile devices. The session transfer further provides the efficient sharing of sessions between devices of multiple users.

In some exemplary embodiments, the systems and methods described above may be implemented in a multi-tenant application system, such as the multi-tenant application system 700 illustrated in FIG. 7. Alternatively, it may be implemented in other computing environments as mentioned above. Referring to FIG. 7, an exemplary multi-tenant application system 700 suitably includes a server 702 that dynamically creates virtual applications 728A-B based upon data 732 from a common database 730 that is shared between multiple tenants. As an example, the database 730 may store the protected data resources discussed above. Data and services generated by the virtual applications 728A-B are provided via network 745 to any number of client devices 740A-B, as desired. Each virtual application 728A-B is suitably generated at run-time using a common platform 710 that securely provides access to data 732 in database 730 for each of the various tenants subscribing to system 700. As examples, the virtual applications 728A-B may correspond to one or more of the modules 110, 120 and servers 130 discussed above, and devices 740A-B may correspond to one or more of the user devices 102, 104 discussed above.

A “tenant” or “organization” generally refers to a group of users that shares access to common data within database 730. Tenants may represent customers, customer departments, business or legal organizations, and/or any other entities that maintain data for particular sets of users within system 700. Using the examples above, a tenant may be a group that enables end users to access protected data resources via a client module. Although multiple tenants may share access to a common server 702 and database 730, the particular data and services provided from server 702 to each tenant can be securely isolated from those provided to other tenants, as described more fully below. The multi-tenant architecture therefore allows different sets of users to share functionality without necessarily sharing each other's data 732.

Database 730 is any sort of repository or other data storage system capable of storing and managing data 732 associated with any number of tenants. Database 730 may be implemented using any type of conventional database server hardware. In various embodiments, database 730 shares processing hardware 704 with server 702. In other embodiments, database 730 is implemented using separate physical and/or virtual database server hardware that communicates with server 702 to perform the various functions described herein.

Data 732 may be organized and formatted in any manner to support multi-tenant application platform 710. In various embodiments, data 732 is suitably organized into a relatively small number of large data tables to maintain a semi-amorphous “heap”-type format. Data 732 can then be organized as needed for a particular virtual application 728A-B. In various embodiments, conventional data relationships are established using any number of pivot tables 734 that establish indexing, uniqueness, relationships between entities, and/or other aspects of conventional database organization as desired.

Further data manipulation and report formatting is generally performed at run-time using a variety of meta-data constructs. Metadata within a universal data directory (UDD) 736, for example, can be used to describe any number of forms, reports, workflows, user access privileges, business logic and other constructs that are common to multiple tenants. Tenant-specific formatting, functions and other constructs may be maintained as tenant-specific metadata 738A-B for each tenant, as desired. Rather than forcing data 732 into an inflexible global structure that is common to all tenants and applications, then, database 730 is organized to be relatively amorphous, with tables 734 and metadata 736-738 providing additional structure on an as-needed basis. To that end, application platform 710 suitably uses tables 734 and/or metadata 736, 738 to generate “virtual” components of applications 728A-B to logically obtain, process, and present the relatively amorphous data 732 from database 730.

Server 702 is implemented using one or more actual and/or virtual computing systems that collectively provide a dynamic application platform 710 for generating virtual applications 728A-B. Server 702 operates with any sort of conventional computing hardware 704, such as any processor 705, memory 706, input/output features 707 and the like. Processor 705 may be implemented using one or more of microprocessors, microcontrol modules, processing cores and/or other computing resources spread across any number of distributed or integrated systems, including any number of “cloud-based” or other virtual systems. Memory 706 represents any non-transitory short or long term storage capable of storing programming instructions for execution on processor 705, including any sort of random access memory (RAM), read only memory (ROM), flash memory, magnetic or optical mass storage, and/or the like. Input/output features 707 represent conventional interfaces to networks (e.g., to network 745, or any other local area, wide area or other network), mass storage, display devices, data entry devices and/or the like. In a typical embodiment, application platform 710 gains access to processing resources, communications interfaces and other features of hardware 704 using any sort of conventional or proprietary operating system 708. As noted above, server 702 may be implemented using a cluster of actual and/or virtual servers operating in conjunction with each other, typically in association with conventional network communications, cluster management, load balancing and other features as appropriate.

Application platform 710 is any sort of software application or other data processing engine that generates virtual applications 728A-B that provide data and/or services to client devices 740A-B. Virtual applications 728A-B are typically generated at run-time in response to queries received from client devices 740A-B, as described more fully below. In the example illustrated in FIG. 7, application platform 710 includes a bulk data processing engine 712, a query generator 714, a search engine 716 that provides text indexing and other search functionality, and a runtime application generator 720. Each of these features may be implemented as a separate process or other module, and many equivalent embodiments could include different and/or additional features, components or other modules as desired.

Runtime application generator 720 dynamically builds and executes virtual applications 728A-B in response to specific requests received from client devices 740A-B. Virtual applications 728A-B created by tenants are typically constructed in accordance with tenant-specific metadata 738, which describes the particular tables, reports, interfaces and/or other features of the particular application. In various embodiments, each virtual application 728A-B generates dynamic web content that can be served to a browser or other client program 742A-B associated with client device 740A-B, as appropriate. Data processing engine 712 performs bulk processing operations on data 732 such as uploads or downloads, updates, online transaction processing and/or the like.

In operation, then, developers use application platform 710 to create data-driven virtual applications 728A-B for the tenants that they support. Such applications 728A-B may make use of interface features such as tenant-specific screens 724, universal screens 722 or the like. Any number of tenant-specific and/or universal objects 726 may also be available for integration into tenant-developed applications 728A-B. Data 732 associated with each application 728A-B is provided to database 730, as appropriate, and stored until requested, along with metadata 738 that describes the particular features (e.g., reports, tables, functions, etc.) of tenant-specific application 728A-B until needed.

Data and services provided by server 702 can be retrieved using any sort of personal computer, mobile telephone, tablet or other network-enabled client device 740A-B on network 745. Typically, the user operates a conventional browser or other client program 742A-B to contact server 702 via network 745 using, for example, the hypertext transport protocol (HTTP) or the like. The user typically authenticates his or her identity to the server 702 to obtain a session identification (“SessionID”) that identifies the user in subsequent communications with server 702. When the identified user requests access to a virtual application 728, application generator 720 suitably creates the application at run time based upon metadata 736 and 738, as appropriate. Query generator 714 suitably obtains the requested data 732 from database 730 as needed to populate the tables, reports or other features of virtual application 728. As noted above, the virtual application 728 may contain Java, ActiveX or other content that can be presented using conventional client software 742A-B running on client device 740A-B; other embodiments may simply provide dynamic web or other content that can be presented and viewed by the user, as desired

Generally speaking, the various functions and features described above may be carried out with any sort of hardware, software and/or firmware logic that is stored and/or executed on any platform. Some or all aspects of exemplary embodiments may be carried out, for example, by logic executing within platform 710 in FIG. 7, for example, using software or firmware logic that is stored in memory and executed by processor as part of application platform. The particular hardware, software and/or firmware logic may vary from context to context, implementation to implementation, and embodiment to embodiment in accordance with the various features, structures and environments set forth herein. The particular means used to implement each of the various functions may be any sort of processing structures that are capable of executing software and/or firmware logic in any format, and/or any sort of application-specific or general purpose hardware, including any sort of discrete and/or integrated circuitry.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 1-7 depicts exemplary arrangements of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for transferring a session between at least two user devices, comprising the steps of:
receiving a transfer command from a first user device during a session to initiate a session transfer;
generating a session code representing the session;
receiving the session code from a second user device; and
reestablishing the session with the second user device.

2. The method of claim 1, wherein the generating step includes generating the session code as a QR (quick response) code.

3. The method of claim 2, further comprising the step of
sending the QR code to the first user device such that the QR code is displayed on the first user device and scanned by the second user device to extract the session code.

4. The method of claim 1, wherein the generating step includes generating the session code with an embedded URL (uniform resource locator).

5. The method of claim 1, wherein the session is associated with a session ID, and wherein the generating step includes generating the session code with the session ID.

6. The method of claim 1, further comprising the step of, prior to the generating step, receiving transfer conditions from the first user device.

7. The method of claim 6, wherein the transfer conditions include at least one of a transfer duration, an asymmetrical view, or an asymmetrical operation.

8. The method of claim 7, wherein the reestablishing step includes reestablishing the session with the second user device subject to the transfer conditions.

9. The method of claim 1, further comprising the step of authenticating the second user device based on the session code.

10. The method of claim 1, further comprising the step of, prior to and during the receiving step,
administering the session with the first device via an application module that accesses data resources in a resource server.

11. The method of claim 10, wherein the administering step includes administering the session via the application module that accesses data resources from a multi-tenant database associated with the resource server.

12. A system for administering data resources, comprising:
a resource server configured to store the data resources; and
an application module configured to establish a session with a first user device for accessing the data resources stored in the resource sever, the application module comprising a transfer module configured to receive a transfer command from the first user device during the session to initiate a session transfer, generate a session code representing the session, receive the session code from a second user device, and reestablish the session with the second user device.

13. The system of claim 12, wherein the application module is configured to generate the session code as a QR (quick response) code and send the QR code to the first user device such that the QR code is displayed on the first user device and scanned by the second user device to extract the code.

14. The system of claim 12, wherein the application module is configured to store session information for the session based on the session code.

15. The system of claim 12, wherein the application module is configured to receive transfer conditions from the first user device.

16. The system of claim 15, wherein the transfer conditions include at least one of a transfer duration, an asymmetrical view, or an asymmetrical operation.

17. The system of claim 16, wherein the application module is configured to reestablish the session with the second user device subject to the transfer conditions.

18. The system of claim 12, further comprising an authorization module coupled to the application module, wherein the authorization module is configured to authenticate the second user device based on the session code.

19. The system of claim 12, wherein the resource server includes a multi-tenant database associated with the resource server.

20. A method for transferring a session with an application module, comprising:
conducting a session on a first user device with the application module;
sending a transfer command to the application module from the first user device;
receiving a session code from the application module representing the session on the first user device as a QR code;
displaying the QR code on the first user device;
scanning the QR code with a second user device;
extracting the session code from the QR code with the second user device;
sending a session request to the application module with the session code from the second user device; and
continuing the session on the second user device.
